(19) United States
(12) Patent Application Publication
(10) Pub. No.: US 2007/0257167 A1
(43) Pub. Date: Nov. 8, 2007

(54) Vacuum suction holder with release position locking structure

(76) Inventor: Harald Richter, Engelbrand (DE)

Correspondence Address: KLAUS J. BACH & ASSOCIATES, 4407 TWIN OAKS DRIVE, MURRYSVILLE, PA, 15668, US

(21) Appl. No.: 11/475,439

(22) Filed: Jun. 27, 2006

(30) Foreign Application Priority Data
May 8, 2006 (DE) 20 2006 007 395.7

(51) Int. Cl. F16B 47/00; A45D 42/14

(52) U.S. Cl. 248/205.8; 248/205.5; 248/206.2

(57) ABSTRACT

In a vacuum suction holder comprising a suction housing having a base opening, a suction membrane extending across the base opening, a membrane operating mechanism including a shaft connected to the suction membrane and being movable together with the suction membrane between a release position in which the suction membrane extends flatly across the base opening and an operating position in which the suction membrane is pulled into the suction housing, the operating mechanism includes means for firmly forcing the suction membrane into the release position in which it extends flat across the suction housing base opening.

### BACKGROUND OF THE INVENTION

The invention resides in a vacuum suction holder as they are known for mounting certain articles to smooth rigid surface area. They are used for example in connection with support structures for mobile telephones, minicomputers or navigation apparatus which are releasably attached for example to vehicle dashboards or windshields of motor vehicles or other smooth surfaces.

Such a vacuum suction holder comprises a suction housing of a bell shape whose interior is closed at the bottom by a flexible suction membrane and a suction membrane operating mechanism including a shaft which, at one end, is connected to the center area of the suction membrane, and extends through a guide opening of the suction housing and, furthermore, is connected to an operating lever or another operating structure. By the operating mechanism, the suction membrane can be moved between a flat, ineffective, release position and an operating position, in which the center area of the membrane is pulled into the suction housing and generates a vacuum between the surface, for example, a windshield, to which the holder is to be attached and the membrane providing for a substantial engagement force.

The operating lever is generally an eccenter cam lever which is connected to the shaft via a transverse pin and whose eccenter cam is supported on the suction housing. As operating levers, also pivot levers are known which are supported so as to be rotatable about the axis of the shaft and which cooperate with a cam structure. Generally, the operating mechanism also includes a spring in the form of a compression coil spring which is arranged between the suction housing and the suction membrane or which engages the end of the operating shaft.

A vacuum suction holder in the form of a suction base arranged on a goose neck apparatus carrier with an eccenter cam operating lever and a compression spring which acts on the membrane operating shaft and is disposed in an upper part of a shaft guide sleeve disposed on the suction housing is known for example from U.S. Pat. No. 6,749,160.

It has always been a problem with such vacuum suction holders that, after a certain period of use they can no longer be properly attached after they have been removed once from their attachment location. This problem occurs particularly pronounced when the suction holders have been attached to windshields where they are heated often to relatively high temperature by the exposure to the solar radiation. If, after removal from such a position, it is attempted to re-attach the suction membrane holders by actuating the operating lever, the vacuum suction holder will often not hold firmly, that is, only with a relatively small engagement force so that it may not even hold its own weight.

It is the object of the invention to provide a vacuum holder with which this problem is eliminated.

### SUMMARY OF THE INVENTION

In a vacuum suction holder comprising a suction housing having a base opening, a suction membrane extending across the base opening, a membrane operating mechanism including a shaft connected to the suction membrane and being movable together with the suction membrane between a release position in which the suction membrane extends flatly across the base opening and an operating position in which the suction membrane is pulled into the suction housing, the operating mechanism includes means for firmly forcing the suction membrane into the release position in which it extends flat across the suction housing base opening.

The invention is based on the recognition that the cause for the problem described above resides in the fact that, after a certain time of use of the vacuum suction holder, the membrane is deformed and does not return to its flat release position but moves back a certain distance toward its curved operating position in the suction housing. The reason herefor resides in the fact that during use of the vacuum suction holder, the membrane is pulled into the housing while it is subjected to the atmosphere pressure, that is, it is under permanent tension while it is often subjected to high temperature. As a result of material creep, it is permanently deformed and has also in the release position the tendency to curve into the housing whereby the shaft is pushed back into the suction housing and a certain amount of air remains between the membrane and the attachment surface so that a high vacuum can no longer be obtained and, accordingly, the engagement forces are substantially reduced. In that case, also the spring often provided for pressing the membrane outwardly into contact with the support surface is insufficient since the membrane which has been radially stretched requires substantial forces to be pressed into contact with the support surface which cannot be provided by the spring. Consequently, when, in this state, the vacuum suction holder is placed onto a support surface and the operating lever is operated the suction membrane is already curved into the housing whereby a substantial part of the operating stroke length is lost and the air present between the membrane and the support surface is expanded permitting the generation of only a relatively small engagement force with the remaining reduced operating stroke.

The present invention solves this problem by providing means for forcing the membrane into the flat release position and holding the operating mechanism together with the membrane flatly in contact with the support surface when the vacuum suction holder is placed onto the support surface. As the operating mechanism is locked in this position, it cannot be pressed back by the deformed membrane. Upon actuation of the operating mechanism—after overcoming release position locking means—with the vacuum suction holder placed firmly onto the support surface, very little air remains between the support surface and the vacuum membrane and, furthermore, the full actuating stroke for the suction membrane is available, that is the vacuum generating capacity is reestablished so that the full retaining force can again be generated.

For a practical realization of the release position, locking structure a number of possibilities are available. Some of them will be described below. It is noted however that the invention is not limited to the embodiments specifically described since the person skilled in the art will be able to conceive, on the basis of this description, other possible solutions.

Preferably, the locking of the release position is established by an elastic engagement structure which retains the operating lever in the release position together with the membrane actuating rod in such a way that it can be moved out of this position only by force. Alternatively, a locking element may be provided which blocks the movement of the shaft and the operating lever or structure in the direction of the shaft axis.

For example, an eccenter cam operating lever may have counter elements which, upon pivoting of the operating lever out of the operating position into the release position, are moved below stop members which are firmly connected to the suction housing or components thereof, for example, a shaft or spring guide sleeve, and which then block an axial movement of the operating lever in the direction of the operating shaft and therefore forcefully hold the membrane in its flat release position. Such an arrangement may be made secure in that a slightly elastic locking function is provided which is easy to achieve because of the elasticity of plastic material of which the operating lever as well as the suction housing consist.

Furthermore, the operating lever and the shaft or spring guide sleeve of the suction housing may be provided with engagement members which retain the operating lever in the release position thereof by a resilient engagement so that it cannot be raised in the direction of the shaft axis, that is, it cannot be pivoted toward the operating position thereof without first overcoming a release force.

Furthermore, since the shaft as well as the shaft guide sleeve or, respectively, the suction housing consist usually of plastic, between the upper end of the shaft and the guide sleeve, an elastic locking structure is provided which is effective in the release position for example by cooperation of radial projections provided on an element and radial recesses provided in another element so that also in this arrangement, the operating lever can be moved to its operating position only by overcoming a substantial initial force which must be applied to the operating lever or operating structure.

Furthermore, an embodiment is conceivable wherein at least a spring-like locking element such as two resilient locking fingers move in the release position behind the end of the shaft for locking the shaft and, for returning the shaft to the operating position, must be displaced by a particular actuation. Such solutions however are less advantageous since they require an additional operating step, that is, the unlocking will not automatically occur by actuating the operating lever or operating member.

A particular embodiment of the invention will be described below on the basis of the accompanying drawings.

### BRIEF DESCRIPTION OF THE DRAWINGS

FIG. 1 is a perspective view of a vacuum suction holder for an apparatus carrier,

FIG. 2 is a side view of the vacuum suction holder in an operating position,

FIG. 3 is a side view of the vacuum suction holder in release position, and

FIG. 4 is a cross-sectional view of FIG. 3.

### DESCRIPTION OF THE PREFERRED EMBODIMENT

The figures show a vacuum suction holder for an apparatus carrier. The suction holder includes a bell-shaped suction housing 1, across the bottom end of which a suction membrane 2 extends. The suction housing 1 is provided with a console 3 for the connection of a goose neck or another support structure. Molded onto the console 3 and the suction housing 1 is furthermore a guide sleeve 4 which, at its lower end, is connected to the center area of suction membrane 2 and which accommodates a spiral compression spring 10 biasing the shaft 2′ downwardly. The arrangement including the shaft 2′ and the spring 10 is known for example from the US patent referred to earlier. The upper end of the shaft is connected to the operating lever 6 via a transverse pin 5. The end of the operating lever 6 connected to the shaft is forked and each end is provided with an eccenter cam 7 rotatable about the transverse pin 5.

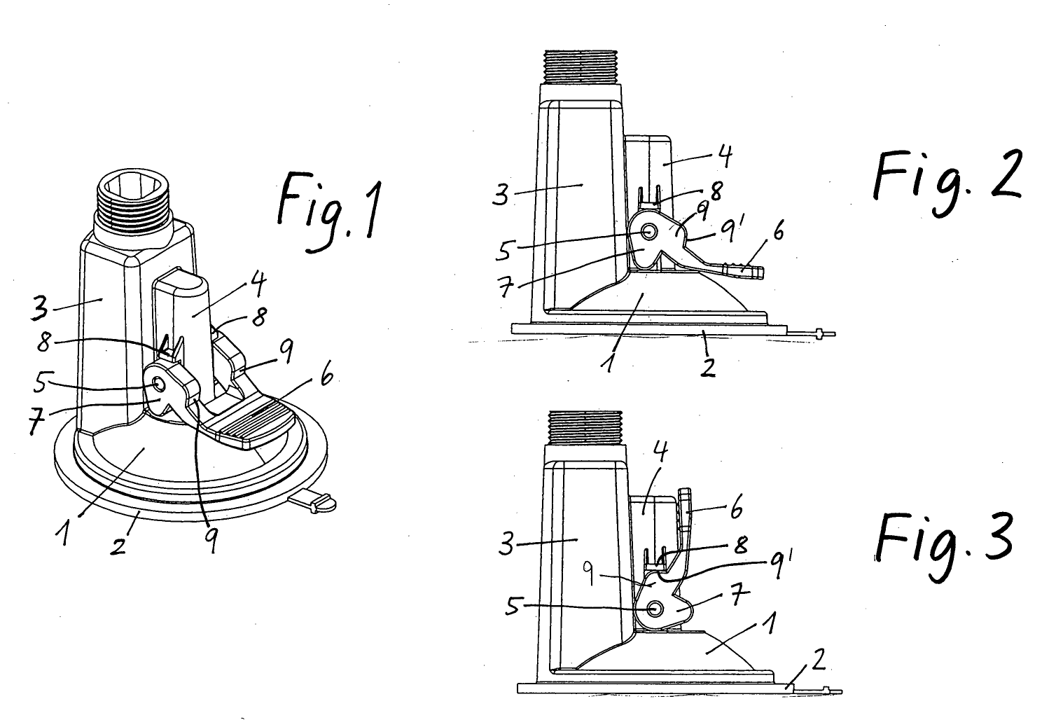

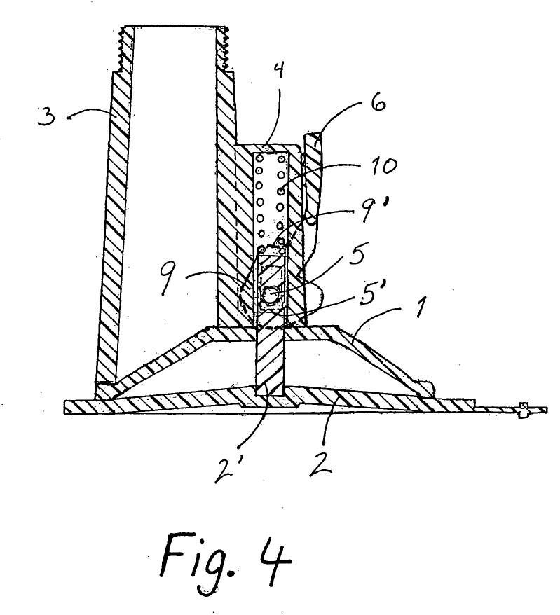

FIGS. 2 and 3 are side views showing the vacuum suction holder with the operating lever 6 in operating position, that is, in the suction position (FIG. 2) and in the release position (FIG. 2).

The guide sleeve 4 is provided with diametrically opposite slots 5′ for accommodating the slide movement of the transverse pin 5 in axial direction of the guide sleeve 4 during the movement of the operating lever 6 between the release and the operating positions. The eccenter cam 7 is supported on the suction housing 1 when the operating lever 6 is pivoted down to the horizontal operating position as shown in FIG. 2. In this position, the transverse pin 5 is disposed at the greatest distance from the suction housing 1 and the operating shaft is pulled upwardly by the transverse pin 5 so that the suction membrane 2 is pulled into the suction housing 1. In FIG. 3, the operating lever 6 is shown into the upwardly pivoted release position in which the eccenter cam 7 is removed from the top side of the suction housing 1 and the transverse pin 5 is disposed closer to the suction housing 1 so that also the operating shaft is moved downwardly to its lower end position together with the suction membrane 2, which is then disposed flat at the bottom of the suction housing 1.

In accordance with the present invention, the operating lever 6 is provided with a release position locking structure for the suction membrane operating mechanism which comprises the operating lever 6, the transverse pin 5, the operating shaft 2′ and the spring 10 in the guide sleeve 4. For retaining the lever 6 and also the operating rod and the suction membrane 2 in the release position retaining brackets 8 are provided on the guide sleeve 4 so as to project over the forked ends of the operating lever 6 and the operating lever is provided with counter cams 9 which abut the retaining brackets 8. In the operating position as shown in FIG. 2, the retaining brackets are not engaged by the counter cams as the cams 7 abut the suction housing 1. However, when the operating lever 6 is pivoted out of the operating position as shown in FIG. 2 into the release position as shown in FIG. 3, the counter cams 9 abut the brackets 8. At their tops, the counter cams 9 are provided with a flattened portion 9′ so that they are firmly seated on the flat bracket surfaces resulting in a retaining force which has to be overcome for movement of the operating lever out of the release position. The arrangement is easy to establish as the operating lever 6 and the guide sleeve 4 with the retaining brackets 8 all consist of plastic. By cooperation of the counter cam 9, with the flat retaining surface area 9′ and the brackets 8, the suction operating mechanisms is firmly held in the release position of the suction membrane 2 and of course, also the membrane 2 is forced into its flattened position even if the membrane has been deformed by previous extended use. A deformed membrane can therefore not bend back into the suction housing 2 because of internal material stresses and, in the process, move the operating shaft upwardly with a certain compression of the compression spring 10, where such a spring is provided, as the operating shaft is locked by the operating lever via the transverse pin 5. The additional engagement between the brackets 8 and the flat surface areas 9′ holds the operating lever 6 in the release position so that it cannot be moved accidentally out of the release position as shown in FIG. 3.

Although the solution of the problem being solved by the present invention is very simple, its effect eliminates the problems of vacuum suction holders described earlier and provides for a substantial advance and use advantage of vacuum suction holders as their operational life span is substantially extended.

What is claimed is:

1. A vacuum suction holder comprising a suction housing (1) having a base opening, a suction membrane (2) extending across the suction housing (1) at the base opening, a membrane operating mechanism including a shaft (2′) connected to the suction membrane (2) and being movable together with the suction membrane (2) between a release position, in which the suction membrane extends flatly across the base opening of the suction housing (1), and an operating position, in which the operating shaft (2′) together with the suction membrane (2) is pulled into the suction housing (1), said operating mechanism including means for forcing the operating shaft 2′ together with the suction membrane (2) into the release position of the suction membrane (2) in which it extends flat across the suction housing opening.

2. A vacuum suction holder according to claim 1, including an operating lever (6) for actuating the operating shaft 2′ so as to move the operating shaft (2′) together with the suction membrane (2) between the release and the operating positions thereof.

3. A vacuum suction holder according to claim 2, wherein the operating lever (6) is pivotally supported on the operating shaft (2′) and includes a cam engaging the suction housing (1) for moving the operating shaft (2′) together with the suction membrane (2) to its operating position.

4. A vacuum suction holder according to claim 3, wherein the operating shaft (2′) is movably supported in a guide housing (4) provided with retaining brackets (8) and the operating lever (6) includes a locking cam (9) abutting the retaining brackets (8) for holding the operating shaft (2′) and, together therewith, the suction membrane (2) in the release position thereof in which the suction membrane (2) extends flat across the suction housing opening.

5. A vacuum suction holder according to claim 4, wherein the locking cam (9) is provided with a flat surface area (9′) where it abuts the retaining brackets (8) in the release position thereof for arresting the locking cam (9) and the operating lever (6) in the release position of the suction membrane (2).

6. A vacuum suction holder according to claim 4, wherein the operating lever (6) has forked ends with the forked ends being disposed at opposite sides of the guide housing (4), each of the forked ends including actuating cams (7) engaging the suction housing (1) for pulling the suction membrane (2) into the housing and locking cams (9) abutting the brackets (8) for forcing the suction membrane (2) firmly into its release position.

7. A vacuum suction holder according to claim 1, wherein a compression spring 10 is disposed in the guide housing (4) above the operating shaft (2′) for biasing the operating shaft (2′) toward the suction membrane (2).
